(19) United States
(12) Patent Application Publication
(10) Pub. No.: US 2012/0000127 A1
(43) Pub. Date: Jan. 5, 2012

(54) FLOWER POT HAVING REMOVABLE BASE

(76) Inventor: CHIN-MIN LIU, Hsinchu County (TW)

(21) Appl. No.: 12/829,627

(22) Filed: Jul. 2, 2010

(51) Int. Cl. A01G 9/02

(52) U.S. Cl. 47/66.1

(57) ABSTRACT

A flower pot having a removable base, comprising: a basin-shaped main body, with its bottom portion or side wall provided with at least an opening, and at least a female connection piece disposed on said basin-shaped main body and around perimeter of said opening; and at least a removable base, having a male connection piece disposed thereon corresponding to said female connection piece, such that the removable base penetrates through said opening and is connected to said basin-shaped main body through connecting said male connection piece to said female connection piece. When a plant in said flower pot has grown up to a certain extent and requires more space, said removable base can be removed, such that the roots of a plant in said flower pot may grow and expand through said opening to a new flower pot, hereby saving the effort and trouble of transplanting.

### BACKGROUND OF THE INVENTION

1. Field of the Invention

The present invention relates to a flower pot, and in particular to a flower pot having a removable base.

2. The Prior Arts

Presently on the market, an ordinary flower pot consists of an integral basin-shaped structure, with its bottom portion provided with a plurality of drainage holes for exiting excessive moisture and water not absorbed by the soil. However, after a plant is placed in a flower pot for a period of time, the sediment sands tend to block the drainage holes, as such impeding the growth and expansion of roots of the plant, and resulting in poor ventilation in the central part of the flower pot, thus it is liable to germinate germs and insects. Moreover, when applying fertilizer to the plant, usually, the fertilizer is sprayed on the surface of soil in the flower pot, therefore the fertilizer has to be seeped downward into the soil for being taken by the plant. Since the seeping uniformity of fertilizer into the soil is not easy to control, thus the excessive fertilizer not absorbed by the plant tends to form blocks with soil or be acidified and/or alkalinized.

In addition, when a plant in a flower pot has grown up to a certain extent, since the original flower pot structure is not able to receive much more soil, therefore, transplant has to be performed to move the plant from the original flower pot to a flower pot of a larger size. Yet in the transplantation process, due to lack of professional knowledge and skill, damages can often be done to the roots of the plant, or it would cause the perish or extinction of the plant.

Therefore, presently, the design and construction of a flower pot of the prior art are not quite satisfactory, and it has much room for improvement.

### SUMMARY OF THE INVENTION

In view of the problems and shortcomings of the prior art, the present invention provides a flower pot having a removable base, that can solve the problem of the prior art.

A major objective of the present invention is to provide a flower pot having a removable base, such that through detaching a removable base, the root of a plant in a flower pot can grow and extend from the original flower pot to a new one without having to go through the trouble of transplant due to the space limitation of the original flower pot.

Another objective of the present invention is to provide a flower pot having a removable base, such that through putting in the removable base various items required for the growth of the plant, such as fertilizer, insecticide, or absorbent, hereby making a plant cultivation much more easy, and convenient.

A further objective of the present invention is to provide a flower pot having a removable base, such that the removable base is able to provide a space in the soil of the flower pot, thus being advantageous to the subsequent enhanced ventilation effort, or subsequent application of more fertilizer, root growth, development, and observation.

In order to achieve the above-mentioned objective, the present invention provide a flower pot having a removable base, comprising: a basin-shaped main body, with its bottom portion or side portion provided with at least an opening, and at least a female connection piece disposed on the basin-shaped main body and around the perimeter of the opening; and at least a removable base, having a male connection piece disposed thereon corresponding to the female connection piece, such that the removable base may penetrate through the opening and connect to the basin-shaped main body through connecting the male connection piece to the female connection piece.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The related drawings in connection with the detailed description of the present invention to be made later are described briefly as follows, in which:

FIGS. 1(a), 1(b), and 1(c) are respectively an exploded view before assembly, a perspective view, and a cross section view of FIG. 1(b) after assembly of a flower pot having a removable base according to the present invention;

FIGS. 2(a) and 2(b) are schematic diagrams showing an old flower pot, and a combination of old and new flower pots having removable bases respectively according to an embodiment of the present invention;

FIG. 2(c) is a schematic diagram showing a combination of old and new flower pots having removable bases according to another embodiment of the present invention;

FIG. 3 is schematic diagram of another flower pot having a removable base according to the present invention;

FIGS. 4(a), 4(b), and 4(c) are respectively an exploded view before assembly, a perspective view, and a cross section view of FIG. 4(b) after assembly of another flower pot having a removable base according to the present invention;

FIGS. 5(a) and 5(b) are an exploded view and a schematic view respectively of another flower pot having a removable base after assembly according to another embodiment of the present invention; and

FIGS. 6(a) and 6(b) are an exploded view and a schematic view respectively of yet another flower pot having a removable base after assembly according to another embodiment of the present invention.

### DETAILED DESCRIPTION OF THE PREFERRED EMBODIMENT

The purpose, construction, features, functions and advantages of the present invention can be appreciated and understood more thoroughly through the following detailed description with reference to the attached drawings. And, in the following, various embodiments are described in explaining the technical characteristics of the present invention.

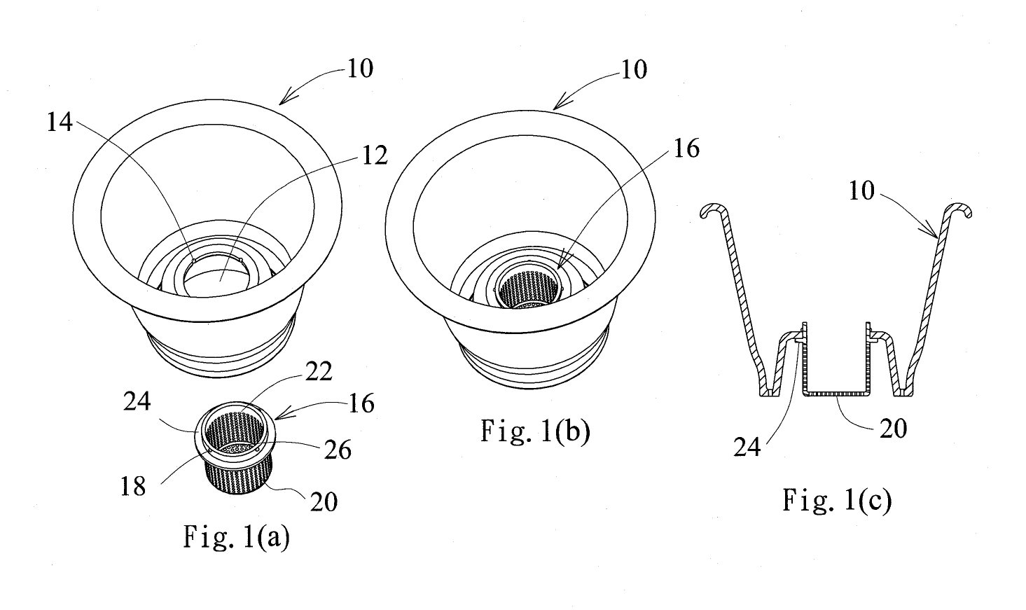

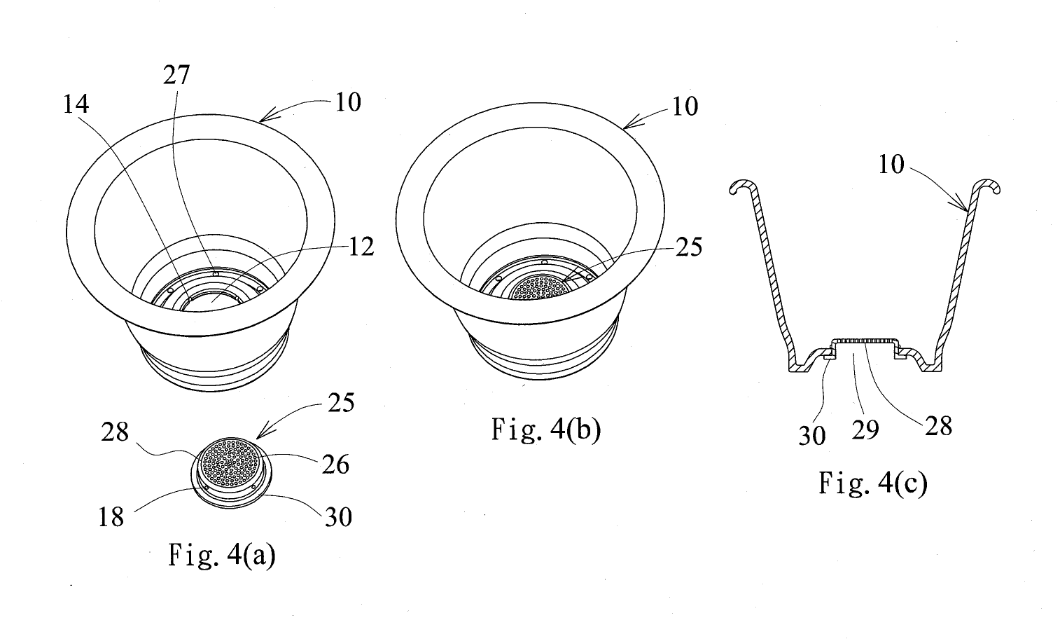

Firstly, refer to FIGS. 1(a), 1(b), and 1(c) respectively for an exploded view before assembly, a perspective view, and a cross section view of FIG. 1(b) after assembly of a flower pot having a removable base according to the present invention. The objective of the present invention is to provide a new kind of flower pot having a removable base, so as to overcome the shortcomings of the prior art that when a plant grows up to a certain extent it has to be transplanted and moved to a new and larger flower pot, comprising: a basin-shaped main body 10, with its bottom portions provided with at least an opening 12, and at least a female connection piece 14 disposed on the basin-shaped main body 10 and around the perimeter of the opening 12; and at least a removable base 16, having a male connection piece 18 disposed thereon corresponding to the female connection piece 14, such that the removable base 16 may penetrate through the opening 12 and connect to the basin-shaped main body 16 through connecting the male connection piece 18 to the female connection piece 14. Wherein, the bottom portion of the basin-shaped main body 10 is provided with a plurality of first holes (refer to element 27 of FIG. 4) for exiting excessive moisture and water. As shown in the drawings, the connection of male connection piece 18 and female connection piece 14 can be achieved through fixing by embedding, or other appropriate means such as through fixing by screwing.

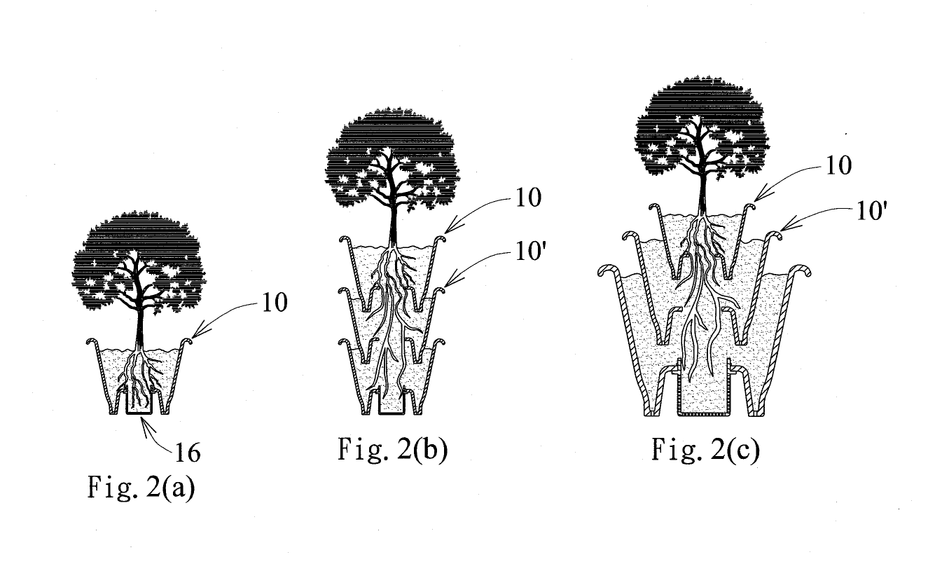

Moreover, refer to FIGS. 2(a) and 2(b) for schematic diagrams showing an old flower pot, and a combination of old and new flower pots having removable bases respectively according to an embodiment of the present invention. As shown in FIGS. 2(a) and 2(b), in the beginning, the flower pot having a removable base of the present invention can be used as an ordinary flower pot. When the plant in the flower pot has grown up, the base 16 can be detached and removed directly, and another basin-shaped main body 10′ can be added to and located below the original basin-shaped main body 10, such that the roots of such a plant can penetrate through the opening 12 and extend to reach another basin-shaped main body 10′, thus there is no need to move and transplant the plant to another flower pot. In the arrangement mentioned above, basin-shaped main body 10 and another basin-shaped main body 10′ are of the same size.

In addition, in case that the other added basin-shaped main body 10′ is of a larger size, then the basin-shaped main body 10 can be placed inside basin-shaped main body 10′, hereby reducing the overall height of the composite flower pots put together, as shown in FIG. 2 (c).

For a detailed description of structure of a removable base 16 mentioned above, refer to FIGS. 1(a), 1(b), and 1(c). As shown in the drawings, the removable base 16 comprises: a first cylinder main body 20, that is able to penetrate through the opening 12, and is provided with an upward opening 22, and a male connection piece 18 is disposed on the outside wall of the upward opening 22 of the first cylinder main body 20, such that the male connection piece 18 is in a form of fastening protrusion block, and the female connection piece 14 is in a form of fastening slot; and a first ring body 24, that is disposed around the outer perimeter of the first cylinder main body 20 and is located below the male connection piece 18. When the removable base 16 is embedded onto the basin-shaped main body 10, the first ring body 24 will press against the bottom of basin-shaped main body 10, so as to prevent effectively the seeping out of soil from the flower pot.

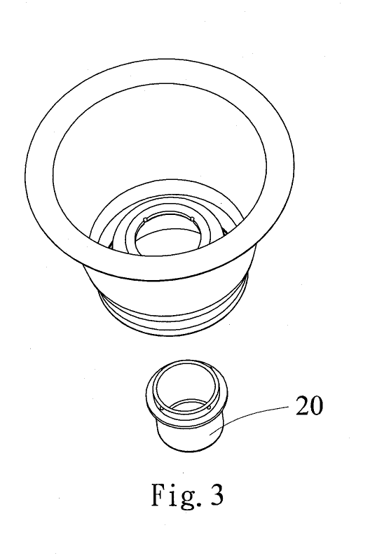

Furthermore, as shown in FIG. 1(a), the first cylinder main body 20 is provided with a plurality of second holes 26 for facilitating ventilation or exit of excessive water; or, alternatively, a water absorption element such as sponge is provided, for absorbing excessive moisture or water in a platter (not shown), so that when the soil is dried up, the moisture in the water absorption element can be diffused into soil through capillary effect for the absorption of the plant. Moreover, as shown in FIG. 3, the first cylinder main body 20 can be designed to have no second openings for accommodating liquid fertilizers, moisture absorption elements, or pesticides. The advantages of putting fertilizer at the bottom of the flower pot is for fast and effective absorption by the roots of a plant. In addition, in the present embodiment, the first cylinder main body 20 can be of a downward protrusion shape, such that the central portion of the bottom of the basin-shaped main body 10 is in an upward protrusion shape, hereby forming a space that is high enough to accommodate the removable base 16.

Then, refer to FIGS. 4(a), 4(b), and 4(c) respectively for an exploded view before assembly, a perspective view, and a cross section view of FIG. 4(b) after assembly of another flower pot having a removable base according to the present invention. As shown in the drawings, the removable base 25 comprises: a second cylinder main body 28, that is able to penetrate through the opening 12, and is provided with a downward opening 29 and a plurality of second holes 26 mentioned above; a second ring body 30, disposed on the outside wall of the downward opening 29 of the second cylinder main body 28; and a male connection piece 18 disposed around the outer perimeter of the second cylinder main body 28 and is located above the second ring body 30. As shown in FIG. 4(b), upon the connection of the removable base 25 to the basin-shaped main body 10, the top surface of the second cylinder main body 28 and the inside bottom surface of the basin-shaped main body 10 are roughly at the same height.

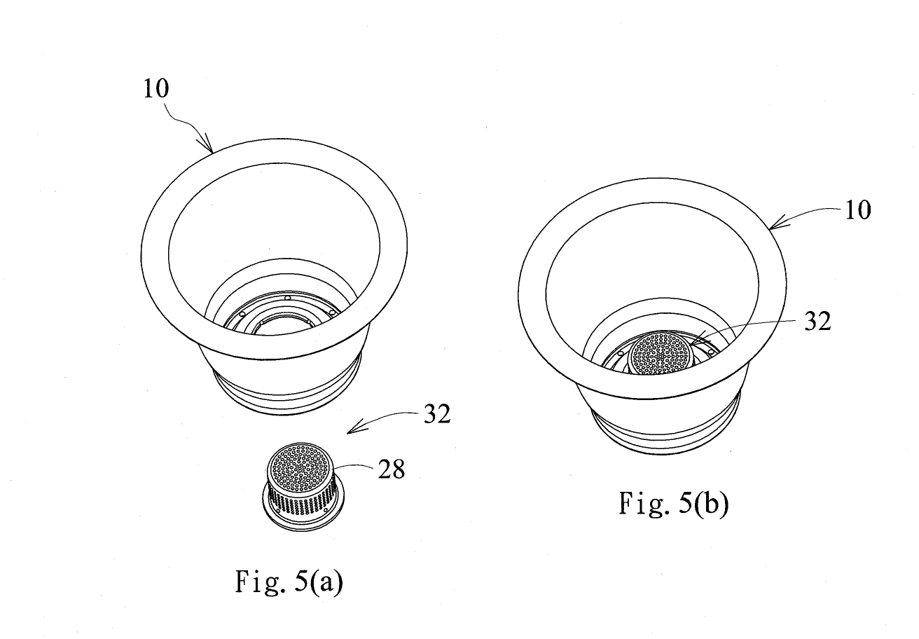

Subsequently, refer to FIGS. 5 (a) and 5(b) for an exploded view and a schematic view respectively of another flower pot having a removable base after assembly according to another embodiment of the present invention. The differences of the present embodiment and that of FIG. 4(a) are that, upon the joining and connection of the removable base 32 and the basin-shaped main body 10, the top surface of the second cylinder main body 28 is higher than the inside bottom surface of the basin-shaped main body 10; as such, creating a space in the soil put in the flower pot, and that is advantageous to the subsequent enhanced ventilation effort, or subsequent application of more fertilizer, root growth, development, and observation. Furthermore, moisture absorption element can be provided in the second cylinder main body 28 for absorbing excessive moisture and water.

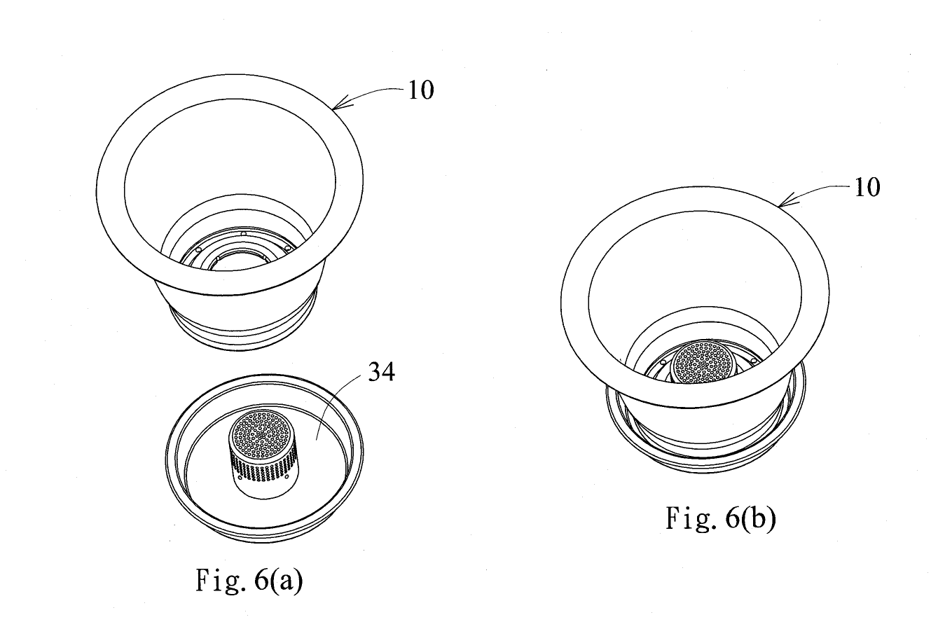

Finally, refer to FIGS. 6(a) and 6(b) for an exploded view and a schematic view respectively of yet another flower pot having a removable base after assembly according to another embodiment of the present invention. The difference of the present embodiment and that of FIG. 4(a) is that, the second ring body 30 is extended outward to form a platter serving as a water receiving platter 34.

Therefore, user may select various types of removable bases depending on their actual requirements. By way of example, in case that liquid fertilizer is utilized for the plant, then the type of removable base of FIG. 3 can be utilized.

Moreover, in addition to being placed at the bottom of the basin-shaped main body, the openings can also be disposed on the side walls of the basin-shaped main body. Then, for this configuration, the removable base in inserted sideways onto the basin-shaped main body.

Summing up the above, the present invention provides a new type flower pot having a removable base, such that through the arrangement of detaching a removable base and placing a new flower pot under the original flower pot, the roots of the plant are able to grow and expand from the original flower pot into the new one without having to go through the trouble of transplant due to the space limitation of the original flower pot. In addition, the type of removable base of a flower pot can be selected depending on actual requirements of the user, hereby making plant cultivation much more easy and convenient.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A flower pot having a removable base, comprising:
a basin-shaped main body, with its bottom portion or side wall provided with at least an opening, and at least a female connection piece disposed on said basin-shaped main body and around an outer perimeter of said opening; and
at least a removable base, having a male connection piece disposed thereon corresponding to said female connection piece, such that said removable base penetrates through said opening and is connected to said basin-shaped main body through connecting said male connection piece to said female connection piece.

2. The flower pot having a removable base as claimed in claim 1, wherein a bottom portion of said basin-shaped main body is provided with a plurality of first holes, to be used as drainage holes.

3. The flower pot having a removable base as claimed in claim 1, wherein said male connection piece is connected to said female connection piece through fixing by embedding, or through fixing by screwing.

4. The flower pot having a removable base as claimed in claim 1, wherein said removable base comprises:
a first cylinder main body, that penetrates through said opening, and is provided with an upward opening;
said male connection piece, disposed on an outside wall of said upward opening of said first cylinder main body; and
a first ring body, disposed around said outer perimeter of said first cylinder main body and is located below said male connection piece.

5. The flower pot having a removable base as claimed in claim 4, wherein on said first cylinder main body is provided with a plurality of second holes to be used as drainage holes.

6. The flower pot having a removable base as claimed in claim 4, wherein said first cylinder main body is provided with space inside for accommodating fertilizer or moisture absorbent elements.

7. The flower pot having a removable base as claimed in claim 1, wherein said removable base comprises:
a second cylinder main body, that penetrates through said opening, and is provided with a downward opening, and a plurality of second holes utilized as said drainage holes;
a second ring body, disposed on said outside wall of said downward opening of said second cylinder main body; and
said male connection piece, disposed on said outer perimeter of said second cylinder main body, and is located above said second ring body.

8. The flower pot having a removable base as claimed in claim 7, wherein said second cylinder main body is provided with space inside for accommodating fertilizer or said moisture absorbent elements.

9. The flower pot having a removable base as claimed in claim 7, wherein said second ring body is extended outward to form a platter serving as a water receiving platter.
